(19) United States
(12) Patent Application Publication
(10) Pub. No.: US 2007/0113571 A1
(43) Pub. Date: May 24, 2007

(54) Hybrid car having control over air-conditioner in idle stop mode and method of controlling air-conditioner in idle stop mode

(76) Inventor: Ji Yeol Park, Seoul (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/520,082

(22) Filed: Sep. 12, 2006

(30) Foreign Application Priority Data
Nov. 24, 2005 (KR) 10-2005-0112898

(51) Int. Cl. F25B 27/00; B60H 1/32

(52) U.S. Cl. 62/236; 62/239; 62/235.1

(57) ABSTRACT

A hybrid car and system having air-conditioner control in the idle stop mode and a method of controlling an air-conditioner of the hybrid car in an idle stop mode to reduce impact caused by applying brake and energy consumption when the hybrid car starts up are provided. The hybrid car and system includes an internal combustion engine, an electric motor to supply power to the hybrid car together with the internal combustion engine, an air-conditioner which is powered by the engine and the motor, an engine control unit controlling run/stop switching so that the air-conditioner is powered by the engine and the motor, and a hybrid control unit determining when the engine control unit to control the run/stop switching of the air-conditioner by using current velocity information transmitted from a velocity sensor and transmitting a run/stop switching order to the engine control unit.

### CROSS-REFERENCE TO RELATED PATENT APPLICATION

This application claims the benefit of Korean Patent Application No. 10-2005-0112898, filed on Nov. 24, 2005, in the Korean Intellectual Property Office, the disclosure of which is incorporated herein in its entirety by reference.

### BACKGROUND OF THE INVENTION

1. Field of the Invention

The present invention relates to a hybrid car and a controlling method thereof, and more particularly to a hybrid car having air-conditioner control in an idle stop mode to reduce impact caused by applying brake and energy consumption when the hybrid car starts up and a system and method for controlling the air-conditioner in the idle stop mode.

2. Description of the Related Art

A hybrid car having a conventional internal combustion engine and an electric motor to support driving the internal combustion engine by charging and discharging of the electric motor is being developed to save costs of fuel and resources and protect air from being polluted. In the aforementioned hybrid car, the internal combustion engine supplies main power and the electric motor supplies auxiliary power to the car. In addition, the hybrid car retrieves the energy which is conventionally wasted and uses the retrieved energy by using the electric motor as a generator when the hybrid car stops.

The hybrid car and the conventional car are different only in terms of engine system. The interior space of the hybrid car is similar to that of the conventional car. That is, convenience means for passengers, a heater, and an air-conditioner are maintained without alteration.

In the air-conditioner of the hybrid car, an air compressor connected to the driving system compresses coolant like the air-conditioner of the conventional internal combustion engine car. Accordingly, operation of the air-conditioner influences the engine system. Particularly, the hybrid car can prevent fuel waste to improve the fuel efficiency by stopping the internal combustion engine in the idle stop mode in which the car temporarily stops. Accordingly, the air compressor of the air-conditioner which is connected to the engine system acts as a large load with respect to the engine system. More specifically, when the hybrid car stops while the air compressor of the air-conditioner is being connected to the engine system, inverse torque generated when the engine stops increases. As a result, a large impact is generated and can be transmitted to the car. Accordingly, the impact makes the passenger uncomfortable and acts as a load with respect to the car. In addition, when the hybrid car departs while the air compressor of the air-conditioner is connected to the engine system, the inverse torque acts as a large load with respect to the internal combustion engine and the electric motor system to drastically increase the consumption of the fuel and the charged electricity. Accordingly, passengers may feel uncomfortable.

### SUMMARY OF THE INVENTION

Embodiments of the present invention provide a hybrid car having control over an air-conditioner in an idle stop mode to reduce impact caused by applying brake and energy consumption when the hybrid car starts up. Embodiments of the present invention also include a system and method for controlling the air-conditioner in the idle stop mode.

According to an one embodiment of the present invention, there is provided a hybrid car having an internal combustion engine and an electric motor for supplying power, the hybrid car including: an air-conditioner which is powered by the engine and the motor; an engine control unit controlling run/stop switching to power the air-conditioner by using the engine; and a hybrid control unit determining when the engine control unit to control the run/stop switching of the air-conditioner by using current velocity information transmitted from a velocity sensor and transmitting a run/stop switching order to the engine control unit.

According to another embodiment of the present invention, there is provided a method of controlling an air-conditioner when a hybrid car having an internal combustion engine, an electric motor to supply power to the hybrid car, an air-conditioner which is powered by the engine and the motor, an engine control unit controlling run/stop switching of the air-conditioner, and a hybrid control unit transmitting a run/stop switching order to the engine control unit by using current velocity information transmitted from a velocity sensor is in an idle stop mode, the method including: a first step of sensing a current velocity of the hybrid car; a second step of comparing a stop velocity at which the air-conditioner is required to stop with the current velocity; a third step of making and transmitting a stop switching order according to the comparison result of the second step; a fourth step of determining whether the car is in the idle stop mode or in a creep driving mode or whether the air-conditioner operates according to current velocity variation; and a fifth step of making and transmitting a run switching order according to the determination result of the fifth step.

### BRIEF DESCRIPTION OF THE DRAWINGS

The above and other features and advantages of the present invention will become more apparent from the detailed description of exemplary embodiments thereof with reference to the attached drawings in which:

FIG. 1 is a block diagram showing an engine, an air-conditioner, an engine control unit, and a hybrid control unit which are included in a hybrid car or system according to an embodiment of the present invention;

FIGS. 2A and 2B are views for explaining an operation of an air-conditioner according to a stop/run order according to embodiments of the present invention;

FIG. 3 is a flowchart of a method of controlling an air-conditioner of a hybrid car in an idle stop mode according to an embodiment of the present invention; and

FIG. 4 is a detailed flowchart of a method of controlling an air-conditioner of the hybrid car in the idle stop mode of FIG. 3.

### DETAILED DESCRIPTION OF THE INVENTION

The above and other objects, features, and functions of the present invention will be apparent from the following detailed description of the embodiments of the invention in conjunction with the accompanying drawings.

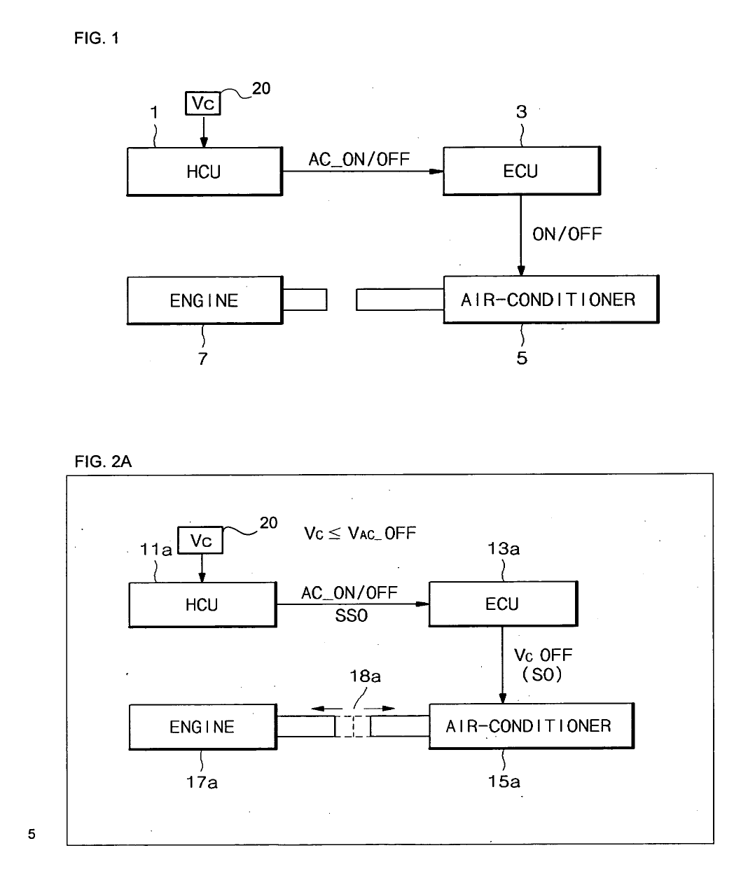

Hereinafter, embodiments of the present invention will be described in detail by explaining exemplary embodiments of the present invention with reference to FIGS. 1 to 4.

Referring to FIG. 1, the hybrid car capable of controlling an air-conditioner in an idle stop mode, or, alternatively, a system capable of such control, includes an air-conditioner 5 which is powered by an engine 7, an engine control unit 3 for controlling run/stop switching to power the air-conditioner 5 by using the engine 7, and a hybrid control unit 1 transmitting a run/stop switching order to the engine control unit 3. Hybrid control unit 1 and engine control unit 3 may comprise a processor, memory and associated hardware and software as may be selected and programmed by persons of ordinary skill in the art based on the teachings of the present invention contained herein.

The hybrid control unit (HCU) 1 determines when the engine control unit (ECU) 3 performs the run/stop switching of the air-conditioner 5 by using current velocity Vc information transmitted from a velocity sensor 20 and transmits a run/stop switching order R/SSO for run/stop switching to the ECU 3. The HCU 1 compares a switching velocity SV with the current velocity Vc and determines the stop/run of the air-conditioner 5 and a stop of an internal combustion engine that is the idle stop (IS). According to the determination, the HCU 1 transmits the run/stop switching order R/SSO of the air-conditioner 5 to the ECU 3 and transmits the stop of the internal combustion engine to the ECU 3 in the idle stop mode. Here, the switching velocity SV is the compared velocity used to stop driving of the air-conditioner 5 in a velocity range in which the idle stop is expected and a velocity range in which the internal combustion engine is required to stop due to the idle stop. That is, the switching velocity SV includes a stop velocity V_{AC}_{_{—}}_{OFF} which is a criterion of determining whether the air-conditioner 5 stops, a run velocity V_{AC}_{_{—}}_{ON} that is the lowest velocity in which the air-conditioner 5 can exit the idle stop mode and normally operate, and an engine stop velocity V_{IS} that is the velocity or the velocity range in which the internal combustion engine is required to stop in response to the idle stop.

The ECU 3 controls the run/stop switching of the air-conditioner 5 in response to the run stop switching order R/SSO received from the HCU 1. That is, when the run switching order RSO is transmitted from the HCU 1 to ECU 3, the ECU 3 connects the air compressor of the air-conditioner 5 to a driving axle of the engine 7 to compress coolant and drive a fan so as to introduce the cooled air inside the car. Selectively, when the stop switching order SSO is transmitted from the HCU 1 to ECU 3, the ECU 3 disconnects the engine 7 from the air-conditioner 5.

The air-conditioner (AC) 5 is connected to or disconnected from the engine 7 to drop a temperature of the air introduced inside the car under the switching control of the ECU 3. The air-conditioner 5 includes the coolant, a circulation pipe for circulating/expanding the coolant, an air compressor for compressing the coolant, and the fan for supporting the circulation of the air introduced inside the car.

The engine 7 includes the internal combustion engine which supplies the main power and an electric motor which supplies an auxiliary power by charging and discharging and performs regenerative braking. The internal combustion engine supplies the main power when the car travels at a normal speed, accelerates, or climes a hill. The internal combustion engine also supplies the main power needed for driving the air-conditioner 5. The electric motor supplies the auxiliary power when the car accelerates or climbs a hill and supplies braking power for the car by generating electricity through the regenerative braking when the car decelerates or stops.

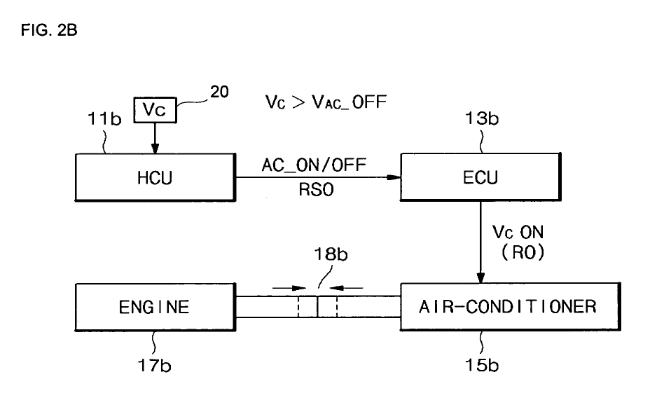

Referring to FIGS. 2A and 2B, the current velocity Vc is reported from a velocimeter or a velocity sensor to the HCU 11a and 11b. When the current velocity Vc is equal to or less than the stop velocity V_{AC}_{_{—}}_{OFF}, the HCU 11a transmits the stop switching order SSO to the ECU 13a. The ECU 13a transmits the run stop signal (SO) to the air-conditioner 15a and stops operation of the air-conditioner 15a, in response to the stop switching order SSO. Accordingly, a control of an element through which the air-conditioner 15a is powered by the engine 17a, for example, a clutch 18a and a removal of the power stop the operation of the air-conditioner 15a.

On the other hand, as shown in FIG. 2B, when the current velocity is recovered to the velocity greater than the run velocity, the HCU 11b transmits the run switching order RSO to the ECU 13b. The ECU 13b transmits the run order RO to the air-conditioner 15a, in response to the run switching order RSO. The air-conditioner 15b restarts operation by controlling the clutch 18b and connecting the engine 17b, in response to the run order RO. Here, the run switching order RSO may be transmitted after a predetermined standby time rather than immediately after a time point when the run velocity V_{AC}_{_{—}}_{ON} exceeds the current velocity Vc. That is, although the current velocity is recovered to the velocity equal to or greater than the run velocity V_{AC}_{_{—}}_{ON}, the current velocity is still low and may decrease to the velocity corresponding to the idle stop mode. Accordingly, 1 to 2 seconds, or several minutes of the standby time may be needed.

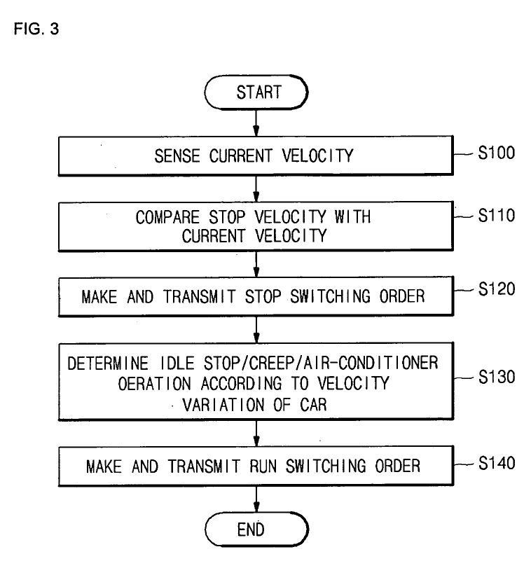

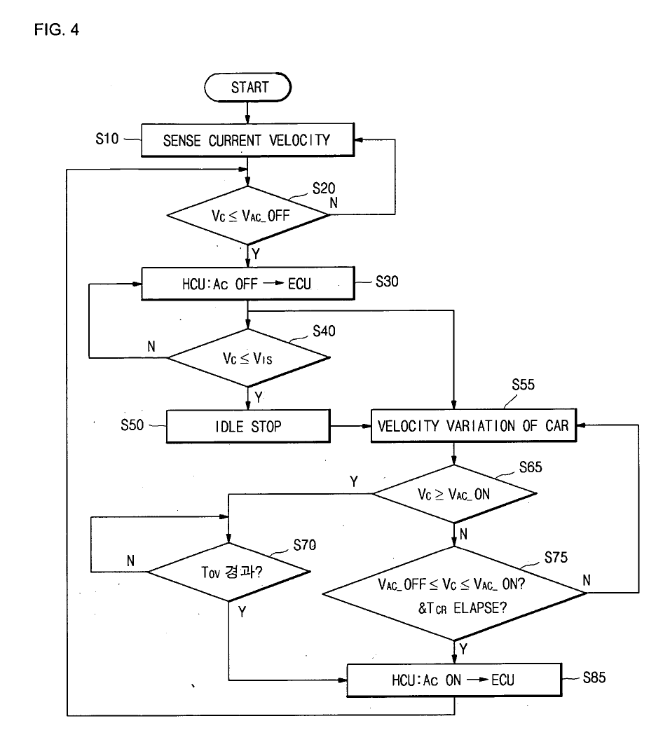

Referring to FIGS. 3 and 4, a method of controlling an air-conditioner in response to an idle stop of a hybrid car will be described in detail.

Referring to FIG. 3, a method of controlling an air-conditioner according to the present invention includes a first step of sensing a current velocity of a hybrid car (S100), a second step of comparing a stop velocity at which the air-conditioner is required to stop with the current velocity (S200), and a third step of making a stop switching order according to the comparison result of the second step (S200) and transmitting the stop switching order (S300), a fourth step of determining whether the car is in the idle stop mode or creep driving mode or whether the air-conditioner operates according to current velocity variation (S400), and a fifth step of making and transmitting the run switching order according to the determination result of the fourth step (S500).

In the first step (S100), the velocity sensor senses the current velocity of the car and continuously transmits the current velocity information (or current velocity) to the HCU 1.

In the second step (S200), the HCU 1 compares the periodically provided current velocity Vc with the stop velocity V_{AC}_{_{—}}_{OFF}. Specifically, the HCU 1 determines whether the current velocity Vc is equal to or less than the stop velocity V_{AC}_{_{—OFF}}.

In the third step (S300), when the current velocity Vc exceeds the stop velocity V_{AC}_{_{—}}_{OFF} according to the comparison result of the second step, the air-conditioner 5 operates normally. On the other hand, when the current velocity Vc is reduced equal to or less than the stop velocity V_{AC}_{_{—}}_{OFF}, the HCU 1 transmits the stop switching order SSO to the ECU 3 to remove the power from the air-conditioner 5. The ECU 3 disconnects the air-conditioner 5 from the engine 7 by transmitting the stop order SO to the air-conditioner 5 according to the stop switching order SSO.

In the fourth step (S400), the velocity sensor senses the velocity variation of the car in the creep driving mode in which the car travels at a low velocity or in the idle stop mode and transmits the sensing result to the HCU 1. The HCU 1 determines whether the car is in the idle stop IS mode or in a creep driving CD mode by determining the velocity variation of the car. Specifically, when the car stops, the HCU 1 instructs the ECU 3 to enable the internal combustion engine to stop and maintains disconnection between the air-conditioner 5 and the engine 7.

Finally, in the fifth step (S500), the HCU 1 makes the run switching order RSO and transmits the run switching order RSO to the ECU 1. When the car maintains in the idle stop (IS) mode or in the creep driving (CD) mode in which the car travels at a low velocity at which the idle stop dose not occur or when the current velocity Vc of the car is equal to or greater than the run velocity V_{AC}_{_{—}}_{ON}, the HCU 1 determines that the car is not in the idle stop mode and transmits the run switching order RSO to the ECU 3. Accordingly, the ECU 3 connects the air-conditioner 5 to the engine 7 to drive the air-conditioner 5 again. Since the car in the CD mode enters the IS mode at any time, the HCU 1 stands ready for a sudden IS mode.

Referring to FIG. 4, a driver starts to drive the hybrid car in a step S10. When the hybrid car starts to travel, the current velocity Vc is periodically reported to the HCU 1 by the velocity sensor.

In a step S20, the HCU 1 compares the periodically provided current velocity Vc with a predetermined stop velocity V_{AC}_{_{—}}_{OFF} of the air-conditioner 5 and determines whether the air-conditioner 5 is required to stop at the current velocity Vc. According to the determination result of the step S20, when the current velocity Vc of the hybrid car is equal to or greater than the stop velocity V_{AC}_{_{—}}_{OFF} of the air-conditioner 5, the HCU 1 continuously drives the air-conditioner 5. The HCU 1 performs the steps S10 and S20 repeatedly so as to determine the stop point of the air-conditioner 5.

When the current velocity Vc drops to the velocity equal to or less than the stop velocity V_{AC}_{_{—}}_{OFF}, in a step S30, to prepare the IS, the HCU 1 makes the stop switching order SSO and transmits the stop switching order SSO to the ECU 3, and the ECU 3 disconnects the air-conditioner 5 from the engine 7.

In a step S40, the HCU 1 determines whether the current velocity Vc reaches the engine stop velocity V_{IS}. Here, the engine stop velocity V_{IS} may be defined as a single velocity value, for example, 0 Km/H, several Km/H, or a velocity range, for example, 0 Km/H˜3 Km/H. When the current velocity does not reach the engine stop velocity V_{IS}, according to the determination result of the step S40, the HCU 1 repeats the steps S10 to S30 to determine the IS. On the other hand, when the current velocity Vc reaches the engine stop velocity V_{IS}, according to the determination result of the step S40, the HCU 1 controls the ECU 3 so that the ECU 3 instructs the internal combustion engine to stop. Therefore, the car enters the IS mode.

After the step S30, in step S55, the HCU 1 checks the current velocity Vc from the velocity sensor and senses the velocity variation of the hybrid car.

In addition, in step S65, the HCU 1 determines whether the current velocity Vc reaches the run velocity V_{AC}_{_{—}}_{ON} of the air-conditioner 5, that is, the velocity at which the air-conditioner 5 restarts the operation.

When the current velocity Vc does not reach the run velocity V_{AC}_{_{—}}_{ON}of the air-conditioner 5 according to the determined result, in step S75, the HCU 1 determines whether duration of the CD is greater than a predetermined creep critical time T_{CR}.

When the CD duration is less than the creep critical time T_{CR}, according to the determined result of the step S75, operations after the step S55 are repeatedly performed. On the contrary, when the CD duration is greater than the creep critical time T_{CR}, the HCU 1 restarts to drive the air-conditioner 5 through the ECU 3.

On the other hand, when the current velocity Vc is greater than the run velocity V_{AC}_{_{—}}_{ON} of the air-conditioner 5, the air-conditioner 5 can operates through the HCU 1 and ECU 3. However, since, in this case, the velocity of the hybrid car is low enough for the car to enter the IS mode suddenly, it is desirable to keep a standby time. That is, in step S70, when the duration in which the current velocity Vc of the hybrid car is greater than the run velocity V_{AC}_{_{—}}_{ON} is greater than predetermined lowest velocity duration T_{OV}, the air-conditioner 5 is driven. Accordingly, the car is prepared for a sudden idle stop IS.

As described above, the hybrid car and system having air-conditioner control in the idle stop mode and the method of controlling the air-conditioner in the idle stop mode according to embodiments of the present invention can reduce impact caused by applying brake and energy consumption when the hybrid car starts up by controlling an operation of the air-conditioner in the idle stop mode. The hybrid car, system and method according to embodiments of the present invention can also prevent increase of the load due to braking and departure of the hybrid car by stopping the operation of the air-conditioner before the idle stop in the velocity range in which the velocity may be regarded as the idle stop mode. In addition, the method can minimize the load due to braking and departure with respect to the hybrid car.

The hybrid car, system and method according to embodiments of the present invention can further determine whether the car is in the creep driving mode or idle stop mode in the velocity range of the idle stop mode and accordingly control the stop/run of the air-conditioner to have passengers feel comfortable and improve the performance of the hybrid car.

Finally, the hybrid car, system and method according to embodiments of the present invention can provide an algorithm in which the operation of the air-conditioner is held for a predetermined time after the velocity of the hybrid car deviates the velocity range of the idle stop mode and prevent the sudden idle stop and the inadequate reaction caused by the sudden idle stop, which in turn reduces the impact with respect to the hybrid car and have passengers feel comfortable.

What is claimed is:

1. A hybrid car having an internal combustion engine and an electric motor to supply power thereto, the hybrid car comprising:
an air-conditioner which is powered by the engine and the motor;
an engine control unit controlling run/stop switching to power the air-conditioner by using the engine and the motor; and
a hybrid control unit determining when the engine control unit to control the run/stop switching of the air-conditioner by using current velocity information transmitted from a velocity sensor and transmitting a run/stop switching order to the engine control unit.

2. The hybrid car of claim 1, wherein the hybrid control unit compares the currently velocity with a predetermined switching velocity and makes the switching order.

3. The hybrid car of claim 2, wherein the switching velocity includes at least one of a stop velocity which is a criterion of determining whether the air-conditioner is required to stop, a run velocity that is the lowest velocity in which the air-conditioner can normally operate by exiting the idle stop mode, and an engine stop velocity that is a velocity or a velocity range in which the internal combustion engine is required to stop in response to the idle stop.

4. The hybrid car of claim 3, wherein, when the current velocity is equal to or less than the stop velocity, the hybrid control unit transmits the stop switching order to the engine control unit.

5. The hybrid car of claim 3, wherein, when the current velocity is equal to or greater than the stop velocity, the hybrid control unit transmits the run switching order to the engine control unit.

6. The hybrid car of claim 5, wherein the run switching order is transmitted to the engine control unit after a time point when the current velocity is equal to or exceeds the run velocity for several seconds or several minutes.

7. A method of controlling an air-conditioner in a hybrid car having an internal combustion engine and an electric motor to supply power to the hybrid car, an air-conditioner which is powered by the engine and the motor, an engine control unit controlling run/stop switching of the air-conditioner, and a hybrid control unit transmitting a run/stop switching order to the engine control unit by using current velocity information transmitted from a velocity sensor is in an idle stop mode, the method comprising:
a first step of sensing current velocity of the hybrid car;
a second step of comparing the current velocity with a stop velocity at which the air-conditioner is required to stop;
a third step of making and transmitting a stop switching order according to the comparison result of the second step;
a fourth step of determining whether the car is in the idle stop mode or in a creep driving mode or whether the air-conditioner operates, according to current velocity variation; and
a fifth step of making and transmitting a run switching order according to the determination result of the fifth step.

8. The method of claim 7, wherein the second or third step comprises:
an operation maintaining step of maintaining the operation of the air-conditioner when the current velocity is greater than the stop velocity; and
an operation stopping step of stopping the operation of the air-conditioner when the current velocity is equal to or less than the stop velocity.

9. The method of claim 7, wherein the third or fourth step comprises determining whether the current velocity is equal to or less than an engine stop velocity at which the internal combustion engine is required to stop.

10. The method of claim 7, wherein the fourth step comprises:
a velocity variation sensing step of sensing current velocity variation;
a normal velocity determining step of determining whether the current velocity is greater than a run velocity at which the air-conditioner operates; and
a creep driving determining step of determining whether the current velocity maintains in the range from the stop velocity to the run velocity when the current velocity is equal to or less than the run velocity.

11. The method of claim 10, wherein the normal velocity determining step further comprises driving restart determining step of determining whether the current velocity is maintained greater than the run velocity for a predetermined time when the current velocity exceeds the run velocity.

12. The method of claim 11, wherein the creep driving determining step or the driving restart determining step further comprises making and transmitting the run switching order when the current velocity is determined to correspond to the creep driving mode or to be greater than the run velocity.

13. A system for air-conditioner control in a hybrid car, the car having an internal combustion engine and an electric motor to supply power thereto, the system comprising:
an air-conditioner which is powered by the engine and the motor;
an engine control unit controlling run/stop switching to power the air-conditioner by using the engine and the motor; and
a hybrid control unit determining when the engine control unit to control the run/stop switching of the air-conditioner by using current velocity information transmitted from a velocity sensor and transmitting a run/stop switching order to the engine control unit.

14. The system of claim 13, wherein the hybrid control unit compares the currently velocity with a predetermined switching velocity and makes the switching order.

15. The hybrid car of claim 14, wherein the switching velocity includes at least one of a stop velocity which is a criterion of determining whether the air-conditioner is required to stop, a run velocity that is the lowest velocity in which the air-conditioner can normally operate by exiting the idle stop mode, and an engine stop velocity that is a velocity or a velocity range in which the internal combustion engine is required to stop in response to the idle stop.

16. The system of claim 15, wherein, when the current velocity is equal to or less than the stop velocity, the hybrid control unit transmits the stop switching order to the engine control unit.

17. The, system of claim 15, wherein, when the current velocity is equal to or greater than the stop velocity, the hybrid control unit transmits the run switching order to the engine control unit.

18. The system of claim 17, wherein the run switching order is transmitted to the engine control unit after a time point when the current velocity is equal to or exceeds the run velocity for several seconds or several minutes.
